(19) United States
(12) Patent Application Publication
(10) Pub. No.: US 2023/0287219 A1
(43) Pub. Date: Sep. 14, 2023

(54) EFFECT PIGMENTS HAVING A REFLECTIVE CORE

(71) Applicant: ECKART AMERICA CORPORATION, Painesville, OH (US)

(72) Inventor: Devin Schmitt, Munster, IN (US)

(21) Appl. No.: 18/012,081

(22) PCT Filed: Jun. 21, 2021
(86) PCT No.: PCT/IB2021/055430

§ 371 Date: Dec. 21, 2022

(30) Foreign Application Priority Data
Jun. 22, 2020 (EP) 20181334.2

(51) Int. Cl. C09C 1/00

(52) U.S. Cl. CPC C09C 1/0015; C01P 2006/60; C09C 2200/301; C09C 2200/1054; C09C 2220/20

(57) ABSTRACT

The present invention relates to an effect pigment having optically active layers consisting of a flake of a highly reflective material with directly adjacent on one side or on both sides a layer of a semiconducting material having a bandgap of 0.1 to 3.5 eV. The effect pigment may be further coated with a coating which is optically non-active in the visible wavelength region.

The present invention relates to effect pigments having a reflective core. In general, effect pigments can be described as flake of platy structures that show light reflectance, scattering, absorption or an optically variable appearance that is dependent on the viewing direction to the substrate whereon or wherein these pigments are applied. Effect pigments are used for example in coatings for the automotive industry or in cosmetics.

Effect pigments are well known in the art and can generally be classified based on the core material for the flake of platy structure, which can be a metal or non-metal. Normally, this core material is coated with a number of different layers to provide for the desired optical effect.

In WO 1999/035194 thin metal effect pigments are disclosed comprising a thin reflector layer, typically a metal, with dielectric coatings disposed on the two opposing planar surfaces of thereof. Other layers can be added to this structure. Examples of suitable dielectric materials include silicon dioxide (SiO₂) and magnesium fluoride (MgF₂). However, the required thickness of the dielectric layers is >50 nm and the resulting chroma effect is low. Flakes will also exhibit colour flop due to path-dependent interference effects. Moreover, all claimed layers adjacent to the metal core are dielectric layers having band gaps >3.5 eV and refractive indexes <2.0.

In US20140368918 and US20150309231 high chroma colour pigments are disclosed in the form of a multilayer stack. US20140368918 describes a pigment consisting of a minimum of a reflective core layer, a semiconductor absorber layer, a dielectric absorber layer but suggests additional dielectric and semiconductor layers for ideal chroma performance. US20150309231 describes a pigment consisting of a minimum of a reflective core layer, a semiconductor absorber layer, a dielectric absorber layer and a high index of refraction dielectric layer. It is said that these type of pigments show a low red hue shift when viewed from a low angle (0 - 45 deg). Such a hue shift will not be observed for the pigments disclosed in WO 1999/035194 using dielectric stacks as the adjacent material. In WO 200/022418 a 7-layer pigment is described colour-shifting dependent upon the angle of incidence of incoming light. The stack is described as a central reflective layer followed by isotropic selective absorbing, dielectric, and absorber layers. However, the structure of these pigments is quite complex and the manufacturing process is rather elaborate.

There is a need for effect pigments having appealing optical properties like colour, flop and high gloss combined with high hiding power but having a simple structure.

Another object is to provide a process to manufacture such effect pigment.

The present invention relates to a thin effect pigment that has a rather simple structure that shows some very favourable optical properties. In one embodiment the present invention relates to an effect pigment having optically active layers consisting of a flake of a highly reflective material with directly adjacent on one side or on both sides a layer of a semiconducting material having a bandgap of 0.1 to 3.5 eV.

Further preferred embodiments are disclosed in claims 2 to 9.

A further object of the invention was solved by providing a method of manufacturing the effect pigment using a PVD process comprising the steps:
a) coating a thin, flexible substrate with a release coat agent,
b) depositing semiconductor layer 1 onto the flexible substrate using a roll-to-roll process,
c) depositing a layer of a reflective metal onto the semiconductor layer 1,
d) depositing a second semiconductor layer 2 onto the reflective metal layer,
e) stripping the material stack from the flexible substrate in a solvent and
f) optionally further steps including particle sizing, particle classification and solvent dispersion.

Further preferred embodiments of this process are disclosed in claims 11 to 13.

A particularly favourable property of the thin effect pigment according to the present invention is an exceptionally high flop index in comparison to known high flop index pigments such as Metalure Liquid Black. The flop index is a measurement of the change in reflectance of a metallic colour as it is rotated through the range of viewing angles. The effect pigment according to the present invention can have a flop index above 25, more particular a flop index above 30. The effect pigment according to the present invention can have a flop index in the range of 25 to 250, more in particular a flop index in the range of 30 to 200 and preferably 35 to 200.

In addition, unlike many interference-based pigments, the effect pigments according to the present invention show little colour shifting as a function of viewing angle.

In a further embodiment, the highly reflective material is selected from the group consisting of aluminium, copper, chromium, titanium or gold.

Preferably the highly reflective material is aluminium.

In a further embodiment the semiconductor material has a bandgap in the range of of 0.1 to 2.5 eV and further preferred in a range of 0.2 to 1.5 eV. Preferably the semiconductor material is selected from germanium, silicon, alloys of germanium and silicon, silicon monoxide, a non-stoichiometric chromium oxide (CrOₓ) or a non-stoichiometric aluminium oxide (AlOₓ). More preferably the semiconductor material is selected from germanium, silicon, alloys thereof and a non-stoichiometric aluminium oxide (AlOₓ), even more preferably it is selected from germanium, silicon or alloys thereof and most preferably the semiconductor material is selected from silicon.

The average molecular stochiometric ratio of oxygen x is in a range of 0.05 to 2.50.

The effect pigment according to the present invention can be represented as a multilayer setup A-B, A-B-A or an A-B-C system, with B being a highly reflective material and adjacent layer A and C a semiconductor material having a bandgap of 0.1 to 3.5 eV. In one embodiment of the present invention, the adjacent layer A or C is a semiconductor material having a bandgap in the range of 0.1 to 1.5 eV. The highly reflective material B is normally a flake or platy material having a mean thickness in the range from 5 to 500 nm, more preferably in the range from 5 to less than 100 nm, even more preferably in the range from 7 to less than 75 nm and most preferably in the range from 10 to 50 nm.

For the purposes of the present invention, the mean thickness of the platy material as well as the thickness of the semiconductor layers are determined by means of a scanning electron microscope (SEM). For effect pigments which do not have a further encapsulation layer the method described in WO 2004/087816 A2 may be used. For effect pigments having a further encapsulation layer a cross section a prepared preferably by incorporating the effect pigments in a concentration of about 10 wt.-% into a two-component clearcoat (Autoclear Plus HS from Sikkens GmbH) with a sleeved brush, applied to a film with the aid of a spiral applicator (wet film thickness 26 µm), dried and cut into cross section. Using this method, the cross section of an adequate number of particles should be measured so as to realize a representative statistical evaluation. Customarily, approximately 100 particles are measured.

The effect pigment according to the present invention may consist of only two or three layers, as reflected above, as a multilayer setup A-B or an A-B-C system, with B being a highly reflective material and adjacent layer A and C a semiconductor material having a bandgap of 0.1 to 3.5 eV. Such layers are optically active within the visible wavelength region.

If both adjacent A and C layers are present, they can be of the same material leading to a A-B-A layer stack or different. Preferably A and C layers are of the same material. The mean thickness of layers A and C can be the same or different. Typically, the mean thickness of layers A and C can be in the range of 5 - 200 nm. Ideally the thickness is <200 nm, more ideally the thickness is <100 nm, and most ideally, the thickness is <75 nm.

For the purposes of the present invention, the mean thickness of the layers A and C is determined by means of a scanning electron microscope (SEM). Using this method, in a cross section of an adequate number of particles the thickness of layers A and C should be measured so as to realize a representative statistical evaluation. Customarily, approximately 100 particles are measured.

Within the scope of the present invention, a dielectric material is an insulator (a poor electrical conductor), such as ceramics, diamond, etc., that typically has a bandgap in excess of ~4 eV. Dielectric materials are typically optically transparent; i.e. they have very poor absorption in the visible region of the electromagnetic spectrum.

In a very preferred embodiment the effect the flake of a highly reflective material is made from aluminium and the semiconductor material having a bandgap of 0.1 to 3.5 eV is selected from the group consisting of germanium, silicon and alloys thereof.

Most preferred is an effect pigment having and A-B-A layer stack, wherein the central layer B is aluminium and the adjacent layers A are silicon.

The effect pigments according to the present invention can be manufactured using a physical vapor deposition (PVD) process. In such process, a thin, flexible substrate, such as PET film, is coated with a release coat agent, which allows the subsequent layers to delaminate or “release” during later processing steps. The release coat step may be skipped if a metallized film is to be produced without intention of stripping the stack material. The semiconductor layer 1 is deposited onto the flexible substrate using a roll-to-roll process with the appropriate semiconductor at the appropriate thickness (thickness 1) to produce the target colour for the web side. In a next step, a 5 - 500 nm layer of a reflective metal is then deposited onto the semiconductor layer 1. In a further step, a second semiconductor layer 2 is then metalized onto the reflective metal layer with the appropriate thickness (thickness 2) to produce the target colour for the metal side. Semiconductor layer 1 and semiconductor layer 2 may be composed of the same or different semiconductor materials. Additionally, thickness 1 and thickness 2 may be the same or different thicknesses. If the semiconductor material and thicknesses of semiconductor layers 1 and 2 are both the same, the colouration will be the same on both sides of the reflective metal.

The above process produces a material stack that may be stripped from the flexible substrate in a subsequent step. The above process may be mirrored on the opposing side of the film, and multiple stacks may be deposited on a single film by repeating the process. Additionally, a single side may be coloured with the opposing side maintaining the metal optical properties by removing one of the semiconductor layers. If semiconductor layer 1 is removed, the metal side will be coloured, while if semiconductor layer 2 is removed, the web side will be coloured.

In the case of pigment manufacturing, the material deposited from the abovementioned substrate is typically stripped utilizing a solvent or mechanical stripping process, followed by post processing steps, which may include particle sizing, particle classification, and solvent dispersion.

The colour and other optical properties of the effect pigment according to the present invention can be made visible and measurable by incorporating the effect pigment in a colourless binder system and by using the obtained composition to coat a substrate. For example, an ink-composition can be obtained by mixing about 6 wt.% of the effect pigment according to the present invention with a colourless nitrocellulose binder and preparing a drawdown on a sample card, for example a BYK Gardner drawdown card.

The optical properties of the material on the drawdown card can be measured using a BYK-mac i MetallicColor.

In general it was found that for the effect pigments according to the present invention, the colour of the pigment shifts from the reddish part of the colour spectrum to the blueish part by increasing the layer thickness of the semiconducting material deposited on the highly reflective material. A similar effect was found by holding the layer thickness of a semiconducting material constant and replacing the semiconducting material with one of a higher refractive index.

In certain embodiments the effect pigments might be encapsulated with a further layer of an optical non-active material. Such encapsulation might be necessary to ensure gassing stability for water-based coating systems or water-based printing inks, for example. At least the edges of the effect pigment are not covered by the semiconductor layer and therefore can be attacked by a corrosive media.

An optically non-active layer it is meant within this invention a layer which reflects less than 20% or preferably less than 10% of incoming light in the optical wavelengths region. Additionally it does not change the chroma response. Particularly, an outer optical non-active layer will exhibit a change of such coated effect pigment compared to the same layer stack effect pigment without an outer non-active layer when applicated in a nitrocellulose lacquer as described in the experimental section of a ΔC*_{15°}of ≤ 2.0 and/or a ΔH*_{15°} of ≤ 10° and preferably ≤ 5° and/or a ΔL*_{15°} of ≤ 10.

In preferred embodiments the optically non-active layer encapsulates essentially the whole effect pigment and consists of a layer of Mo-oxide, SiO₂, Al₂O₃, or surface modifiers like organofunctional silanes, phosphate ester, phosphonate esters, phosphite esters and combinations thereof.

More preferably the optically non-active layer encapsulates the whole effect pigment and consists of a layer of Mo-oxide, SiO₂ and optionally a surface modifier like organofunctional silanes. Such systems are described e.g. in WO 2019/110490 A1. In another preferred embodiment the optically non-active layer consists of a layer of SiO₂ and optionally a layer of organofunctional silanes.

The organofunctional silanes are primarily needed as surface modifiers here to adjust the chemical compatibility of the effect pigment to the binder medium of the final application as described in e.g. EP 1084198 A1.

The organofunctional silanes used preferably as surface modifiers, which contain suitable functional groups, are available commercially and are produced, for example, by Evonik, Rheinfelden, Germany and sold under the trade name “Dynasylan®”. Further products can be purchased from OSi Specialties (Silquest® silanes) or from Wacker (Genosil® silanes).

Examples of suitable organofunctional silanes are 3-methacryloxypropyl trimethoxy silane (Dynasylan MEMO), vinyl tri(m)ethoxy silane (Dynasylan VTMO or VTEO), 3-mercaptopropyl tri(m)ethoxy silane (Dynasylan MTMO or 3201), 3-glycidyloxypropyl trimethoxy silane (Dynasylan GLYMO), tris(3-trimethoxysilylpropyl) isocyanurate (Silquest Y- 11597), gamma-mercaptopropyl trimethoxy silane (Silquest A-189), bis(3-triethoxysilylpropyl) polysulfide (Silquest A-1289), bis(3-triethoxysilyl) disulfide (Silquest A-1589), beta(3,4-epoxycyclohexyl) ethyltri-methoxysilane (Silquest A-186), gamma-isocyanatopropyl-trimethoxsilane (Silquest A-Link 35, Genosil GF40), (methacryloyloxymethyl) trimethoxysilane (Genosil XL 33) and (isocyanatomethyl)trimethoxysilane (Genosil XL 43).

In one preferred embodiment the organofunctional silane mixture that modifies the SiO₂ layer comprises at least one amino-functional silane. The amino function is a functional group which is able to enter into chemical interactions with the majority of groups present in binders. This interaction may involve a covalent bond, such as with isocyanate or carboxylate functions of the binder, for example, or hydrogen bonds such as with OH or COOR functions, or else ionic interactions. It is therefore very highly suitable for the purpose of the chemical attachment of the effect pigment to different kinds of binder.

The following compounds are employed preferably for this purpose: aminopropyl trimethoxy silane (Dynasylan AMMO), aminopropyl triethoxy silane (Dynasylan AMEO), N-(2-aminoethyl)-3-aminopropyl trimethoxy silane (Dynasylan DAMO), N-(2-aminoethyl)-3-aminopropyl triethoxy silane, triamino-functional trimethoxy silane (Silquest A-1 130), bis(gamma-trimethoxysilylpropyl)amine (Silquest A-1 170), N-ethyl-gamma-aminoisobutyl trimethoxy silane (Silquest A-Link 15), N-phenyl-gamma-diaminopropyl trimethoxy silane (Silquest Y-9669), 4-amino-3,3-dimethylbutyltrimethoxy-silane (Silquest Y-11637), (N-cyclohexylaminomethyl)-triethoxy silane (Genosil XL 926), (N-phenylaminomethyl)-trimethoxy silane (Genosil XL 973) and mixtures thereof.

In another embodiment pre-hydrolysed and pre-condensated organofunctional silanes may be used as described in EP 3080209 B1.

In other embodiments the organofunctional silanes or other corrosion inhibitors like phosphate ester, phosphonate esters, phosphite esters and combinations thereof may be coated directly on the effect pigment to impart corrosion and gassing stability especially to the edges of the effect pigment.

The effect pigments according to the present invention can be used of a broad range of applications, typically for metallic effect pigments, such as coatings, inks, cosmetics.

Coating or ink compositions comprising these effect pigments can show a very high flop index, for example a flop index in the range of 30 - 200 or preferably in the range of 35 to 200.

Some further aspects of this invention relate to a coated film of the material stacks described before. Such films can be regarded as precursor materials for the manufacture of the final effect pigments.

Aspect 1 relates to a film coated on a flexible substrate with a first layer of a semiconductor with a band gap of 0.1 to 3.5 eV and a layer of a reflective material coated thereon.

Aspect 2 relates to aspect 1, wherein a further layer of semiconductor material is coated on the layer of a highly reflective material.

Aspect 3 relates to aspects 1 or 2, wherein the highly reflective material is selected from the group consisting of aluminium, copper, chromium, titanium or gold.

Aspect 3 relates to any of the preceding aspects wherein the semiconductor materials having a bandgap of 0.1 to 3.5 eV are selected from the group consisting of germanium, silicon, alloys of germanium and silicon, silicon monoxide, a non-stoichiometric chromium oxide (CrOₓ) or a non-stoichiometric aluminium oxide (AlOₓ).

Aspect 4 relates to aspect the FIGURE, wherein the semiconductor material having a bandgap of 0.1 to 3.5 eV is selected from the group consisting of germanium, silicon and alloys thereof.

Aspect 5 relates to any of the preceding aspects, wherein the flake of a highly reflective material has an average thickness in the range from 5 to 500 nm.

Aspect 6 relates to any of the preceding aspects, wherein the layer of the semiconductor material has a mean thickness in the range from 5 to 200 nm.

Aspect 7 relates to any of the preceding aspects, wherein the highly reflective material is aluminium and the semiconductor material is selected from the group consisting of germanium, silicon and alloys of germanium and silicon.

### EXAMPLES

### Pre-Examples 1: 2-layer Material (Al—Ge)

A layer of 1.0 – 1.5 optical density (OD) aluminium was deposited on a 30 cm wide clear polyester film coated with a CAB (cellulose acetobutyrat) based release agent using ebeam PVD evaporation. Enough Al was deposited onto the web to complete the second step below and provide an Al-only web for comparison. The ebeam source was positioned 36 cm below the web during process and webspeed was held at a constant 9 m/min. The ebeam source accelerating voltage was held at a constant 10 kV throughout the run. In the second step, a layer of Ge was deposited on top of the aluminium layer. Ebeam current was varied per condition. The web was stopped and the shutter closed during condition changes, which provided a clear visible condition delineation during post-run web observations.

Using the set-up described above, Ge with different thickness were deposited on the aluminium layer, giving a colouration from blue (thicker layers) to red (thinner layers). The results are summarised in Table 1.

TABLE 1

| Example | Ge-depostion Ebeam current (A) | Colour |
|---|---|---|
| 1a | 0 | Silver |
| 1b | 0.180 | Light yellow |
| 1c | 0.190 | Gold |
| 1d | 0.200 | Orange |
| 1e | 0.220 | Magenta |
| 1f | 0.240 | Blue |
| 1g | 0.250 | Teal |
| 1h | 0.260 | Teal-silver |

### Examples 2: 3-layer Material (Ge—Al—Ge)

In a similar set-up as in example 1, 3-layer materials were produced. The ebeam source was positioned 36 cm below the web during process and webspeed was held at a constant 10 m/min. The ebeam source accelerating voltage was held at a constant 10 kV throughout the run. In a first step a Ge-layer was deposited on a clear polyester film with a release coat layer using PVD ebeam evaporation. Rudimentary in-situ optical transmission sensors were utilized to determine the germanium thickness, and ebeam current was manipulated to target appropriate germanium thickness. In a next step an Al layer was deposited corresponding to approximately 0.9 - 1.5 OD. Optical transmission sensors in combination with current adjustment was utilized to target appropriate Al thickness. A third process step a further layer of Ge was deposited. Again, in-situ optical transmission sensors were utilized to determine the germanium thickness, and ebeam current was manipulated to target appropriate germanium thickness. The thickness of the 2 germanium layers was targeted to be the same, so that the webside and metal side of each condition would be the same colour. Orange, purple, and blue colouration were targeted and successfully produced in 3 separate conditions. The colouration of the web and metal side of the films matched well in each material set.

The process conditions are summarized in Table 2

TABLE 2

| Example | In-situ Optical Trans (%) | Average Ge layer thickness (nm) | In-situ Optical Trans (%) | Average Al Layer thickness (nm) |
|---|---|---|---|---|
| 2a | 63 | 10 | 19 | 25 nm |
| 2b | 49 | 14.5 | 18 | 25 nm |
| 2c | 40 | 29 | 19 | 20 nm |

The materials obtained in Example 2 were all stripped from the polyester film and milled/crushed to a particles size listed below (D50 value). Pigments were prepared with a 20 wt.% in GEPM. Inks were prepared using a total metals content specified below in Eckart’s in-house LQ5797 nitrocellulose binder system. The samples were drawn down on a flat BYK drawdown card. Gloss data were collected using a BYK Micro Tri-gloss meter. Additional optical data were collected using a BYK Mac meter. The results of these measurements are summarised in Table 3.

TABLE 3

Optical data of Examples 2

| Sample | Particle Size D50 (µm) | Metals Content (%) | Gloss 60° | Gloss 85° | Flop Index | L*_{(15°)} (trans) | L*_{15°} | L*_{45°} | a*_{15°} | b*_{15°} | Visual colour |
|---|---|---|---|---|---|---|---|---|---|---|---|
| 2a | 15 | 2.5 | 97.6 | 61.6 | 28.1 | 127.8 | 106.3 | 24.3 | 7.5 | 26.2 | Orange |
| 2b | 11 | 4.5 | 52.8 | 78.5 | 43.4 | 95.4 | 78.1 | 10.6 | 14.4 | -3.1 | Purple |
| 2c | 11 | 4.5 | 55.0 | 75.4 | 43.7 | 93.3 | 75.9 | 10.1 | -9.7 | -17.9 | Blue |

### Examples 3: 3-Layer Material (Ge—Al—Ge) and Effect Pigments

In a similar set-up as in example 2, 3-layer materials were produced. The ebeam source was positioned 36 cm below the web during process and webspeed was held at a constant 10 m/min. The ebeam source accelerating voltage was held at a constant 10 kV throughout the run. In a first step a Ge-layer was deposited on a clear polyester film with a release coat layer using PVD ebeam evaporation. Ebeam current was set at the beginning of the run and webspeed was utilized to manipulate the germanium layer thicknesses. In a next step an Al layer was deposited corresponding to approximately 1.0 - 1.5 OD. Optical transmission sensors in combination with current adjustment was utilized to target appropriate Al thickness. In a third process step a further layer of Ge was deposited using the same parameters as the first step. Again, ebeam current was set at the beginning of the run, but in this example webspeed was utilized to manipulate the germanium layer thicknesses. The thickness of the 2 germanium layers was targeted to be the same, so that the webside and metal side of each condition would be the same colour. Yellow, orange, burgundy, royal blue, and teal colouration were successfully produced. The colouration of the web and metal side of the films matched well in each material set.

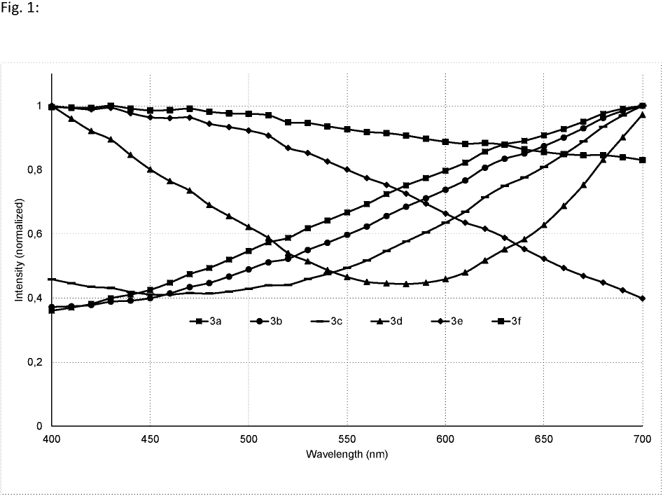

The materials obtained in Example 3 were all stripped from the polyester film and milled/crushed to a particle size of approximately 20 microns (D50 value). Pigments were prepared with a 20 wt.% in GEPM. Inks were prepared using a total metals content specified below in Eckart’s in-house LQ5797 nitrocellulose binder system. The samples were drawn down on a flat BYK drawdown card. Gloss data were collected using a BYK Micro Tri-gloss meter. A comparison to commercially available Metalure Liquid Black is shown in Table 4, comparative example 3f. Additional optical data were collected using a BYK Mac meter. The results of these measurements are summarised in Table 4. Further the normalized spectral response at 15 degrees of materials 3a - 3f is shown in FIG. 1.

TABLE 4

Optical values for Examples 3

| Sample | Metals Content (%) | Gloss 60° | Flop Index | L_{(-15°)} (trans) | L_{15°} | L_{45°} | a*_{15°} | b*_{15°} | Visual colour |
|---|---|---|---|---|---|---|---|---|---|
| 3a | 3.0 | 147 | 41.1 | 114.0 | 93.4 | 14.0 | 7.6 | 24.6 | Gold |
| 3b | 3.5 | 114 | 43.0 | 101.6 | 82.0 | 11.3 | 9.6 | 20.9 | Orange |
| 3c | 4.0 | 82.9 | 52.5 | 86.4 | 69.3 | 7.3 | 12.1 | 10.3 | Burgundy |
| 3d | 4.5 | 66.6 | 75.7 | 63.9 | 49.1 | 3.1 | 5.5 | -17.3 | Royal Blue |
| 3e | 5.0 | 65.8 | 46.7 | 91.2 | 74.9 | 9.1 | -7.7 | -10.5 | Teal |
| 3f^{#} | 3.2 | 62.0 | 31.0 | 110.4 | 92.2 | 19.0 | -2.0 | -3.5 | Dark Chrome |

^{#)}: Comparative example

### Examples 4: 3 Layer Material (Ge—Cu—Ge)

In a similar set-up as in example 1, a 3-layer material was produced with Cu as the central metallic layer. The ebeam source was positioned 36 cm below the web during process and webspeed was held at a constant 10 m/min. The ebeam source accelerating voltage was held at a constant 10 kV throughout the run. In a first step a Ge-layer was deposited on a clear polyester film with a release coat layer using PVD ebeam evaporation. Rudimentary in-situ optical transmission sensors were utilized to determine the germanium thickness, and ebeam current was manipulated to target appropriate germanium thickness. In order to target a red colouration, a Ge thickness target of approximately 10 nm was targeted by utilizing SEM and optical data obtained from example 2. In a next step a Cu layer was deposited corresponding to approximately 2.0 - 3.0 OD. Optical transmission sensors in combination with current adjustment was utilized to target appropriate Cu thickness. According to SEM micrographs, a Cu thickness of approximately 50 nm was achieved. A third process step a further layer of Ge was deposited. Again, in-situ optical transmission sensors were utilized to determine the germanium thickness, and ebeam current was manipulated to target appropriate germanium thickness. The thickness of the 2 germanium layers was targeted to be the same, so that the webside and metal side of each condition would be the same colour. Red colouration was targeted and successfully produced in 3 separate conditions. The colouration of the web and metal side of the films matched well in each material set.

The materials obtained in Example 4 were all stripped from the polyester film and milled/crushed to a particles size of approximately 15 microns (D50 value). Pigments were prepared with a 23 wt.% in GEPM. Cu-based PVD pigments are typically difficult to stabilize, however, the germanium surface coating appears to impart at least some chemical stability, allowing the pigments to be post-processed without substantial optical degradation. Inks were prepared using a total metals content of 6.0% in Eckart’s in-house LQ5797 nitrocellulose binder system. The samples were drawn down on a flat BYK drawdown card. Optical data for a sample of Metalure Liquid Black (4b) at 3.2% solids is shown for comparison. Gloss data were collected using a BYK Micro Tri-gloss meter. Additional optical data were collected using a BYK Mac meter. The results of these measurements are summarised in Table 5a and 5b.

TABLE 5a

| Sample | Metal Content (%) | Gloss 20° | Gloss 60° | Flop Index | L*_{(-15°)} (trans) | L*_{15°} | L*_{45°} | Visual colour |
|---|---|---|---|---|---|---|---|---|
| Ex. 4a | 6.0 | 21.9 | 63.0 | 25.5 | 129.6 | 109.5 | 27.4 | Red |
| Comp-Ex. 4b | 3.2 | 20.0 | 62.0 | 31.0 | 110.4 | 92.2 | 19.0 | Dark Chrome |

TABLE 5b

a*,b* values for Examples 5

| Sample | a*15 | a*25 | a*45° | a*75° | a*110° | b*15° | b*25° | b*45° | b*75° | b*110 |
|---|---|---|---|---|---|---|---|---|---|---|
| Ex. 4a | 20.7 | 14.4 | 8.5 | 6.5 | 6.5 | 20.9 | 14.9 | 8.7 | 6.2 | 5.8 |
| Comp. Ex. 4b | -1.9 | -0.8 | -0.3 | -0.1 | -0.1 | -3.5 | -0.6 | 0.5 | 0.4 | 0.27 |

### Pre-Example 5: 2 Layer Film (Cr—CrOx)

In a similar set-up as in example 1, 2-layer films were produced with Cr as the first metallic layer. The ebeam source was positioned 36 cm below the web during process. The ebeam source accelerating voltage was held at a constant 10 kV throughout the run. A Cr layer was deposited corresponding to approximately 1.0 - 2.0 OD for the initial reflective metallic layer. A second layer of Cr with oxygen streamed into the plume was deposited to generate a CrOx layer atop the Cr metallic layer. Webspeed was held constant at 36 m/min and current was varied from 150 mA to 290 mA in 20 mA increments. The shutter was closed between source current modifications. This process was repeated for 18 m/min and 9 m/min webspeed, with the realization of increasing CrOx thickness from high to low webspeed and low to high ebeam current. In a separate experiment, according to SEM micrographs, a CrOx thickness of approximately 70 - 80 nm corresponds to a strong blue colouration.

The resulting film varies in colour (from thinnest to thickest CrOx) in the following order: light yellow, orange, burgundy, purple, royal blue, blue, teal, green, green-yellow. Gloss data were collected using a BYK Micro Tri-gloss meter. Additional optical data were collected using a BYK Mac meter. The results of these measurements are summarised in Table 6.

TABLE 6

Optical data for Pre-Examples 5

| Current | Web Speed | Gloss 20° | Gloss 60° | Flop Index | L*_{15°} | L*_{45°} | a*_{15°} | b*_{15°} |
|---|---|---|---|---|---|---|---|---|
| control | m/min | 300 | 310 | 26.32 | 8.31 | 1 | 1.19 | 4.38 |
| 150 | 36 | 150 | 306 | 27.26 | 10.99 | 1.54 | 0.22 | 4.21 |
| 170 | 36 | 133 | 297 | 24.69 | 10.17 | 1.22 | 0.53 | 4.98 |
| 190 | 36 | 84.2 | 254 | 33.29 | 19.65 | 1.62 | 1.4 | 7.69 |
| 210 | 36 | 45.6 | 215 | 35.44 | 7.9 | 1.1 | 1.56 | 5.73 |
| 230 | 36 | 44.4 | 198 | 26.81 | 6.83 | 0.97 | 1.2 | 5.78 |
| 250 | 36 | 46.2 | 194 | 130.7 | 17 | 1.13 | 3.51 | 10.86 |
| 270 | 36 | 22.9 | 162 | 119.53 | 39.99 | 0.79 | 8.93 | 26.77 |
| 290 | 36 | 49.3 | 163 | 130.2 | 3.42 | 0.66 | 1.85 | 3.6 |
| 150 | 18 | 70.8 | 197 | 26.06 | 6.48 | 1.14 | 1.93 | 5.09 |
| 170 | 18 | 27.7 | 162 | 82.34 | 13.83 | 0.98 | 8.5 | 15.45 |
| 190 | 18 | 22.5 | 147 | 112.41 | 27.96 | 1.1 | 15.81 | 27.29 |
| 210 | 18 | 7.4 | 107 | 51.74 | 4.05 | 0.75 | 2.68 | 2.5 |
| 230 | 18 | 5.3 | 91 | 86.52 | 4.59 | 0.95 | 3.58 | -0.86 |
| 250 | 18 | 4.8 | 70.4 | 30.98 | 5.92 | 1.01 | 6.05 | -8.22 |
| 270 | 18 | 14.5 | 69.6 | 95.66 | 6.49 | 1.11 | 2.89 | -10.21 |
| 290 | 18 | 12.7 | 69 | 88.95 | 5.95 | 1.4 | 2.49 | -4.93 |
| 150 | 9 | 91.1 | 132 | 28.9 | 10.91 | 1.63 | -0.94 | -6.97 |
| 170 | 9 | 119 | 173 | 29.08 | 19.33 | 2.56 | -4.14 | -9.17 |
| 190 | 9 | 112 | 204 | 39.05 | 22.2 | 1.82 | -5.44 | -7.06 |
| 210 | 9 | 65.7 | 199 | 83.54 | 39.39 | 4.11 | -7.71 | -13.64 |
| 230 | 9 | 63.4 | 191 | 111.15 | 40.6 | 4.97 | -6.21 | -11.62 |
| 250 | 9 | 84.6 | 206 | 86.86 | 35.08 | 4.27 | -5.98 | -4.47 |
| 270 | 9 | 33.2 | 138 | 189.33 | 59.05 | 10.19 | -6.55 | 5.14 |
| 290 | 9 | 41.9 | 145 | 94.39 | 48.87 | 5.88 | -5.38 | 3.62 |

### Examples 6: 2 Layer Film (Si—Al)

In a similar set-up as in example 1, 2-layer films were produced with Si as the first semiconducting layer. The ebeam source was positioned 36 cm below the web during process. The ebeam source accelerating voltage was held at a constant 10 kV throughout the run. A Si layer was deposited at a fixed current of 332 mA and webspeed was varied discretely from 6-34 m/s to control Si layer thickness. The shutter was closed between webspeed modifications to signal condition changes during film analysis. Previous silicon depositions using this current setting at 11 m/s webspeed resulted in a Si thickness of 29 +/-2 nm. The expected Si thickness range, therefore, is between 7 nm and 60 nm for the webspeed endpoints of 34 m/s and 6 m/s, respectively. A second layer of metallic Al with thickness corresponding to an optical density of approximately 1.0 - 1.5 OD was deposited atop the Si semiconducting layer.

The resulting film displays silver coloration on the Al metal side and varies in colour on the Si side from thinnest deposited Si (highest webspeed) to thickest deposited Si (lowest webspeed) in the following order: light yellow, gold, orange, purple, royal blue, blue, teal, teal-green. All films displayed highly reflective visual characteristics with excellent clarity on both silver and coloured sides. Optical colorimetry data were collected using a BYK Mac meter on the coloured film side. The results of these measurements are summarised in Table 7.

TABLE 7

Optical date for Example 6 series

| Sample | Web speed (m/min) | Visual Color | a*_{15°} | a*_{25°} | a*_{45°} | a*_{75°} | a*_{110°} | b*_{15°} | b*_{25°} | b*_{45°} | b*_{75°} | b*_{110°} | Flop Index |
|---|---|---|---|---|---|---|---|---|---|---|---|---|---|
| Ex. 6a | 7 | Teal-green | -8.00 | -3.92 | -1.58 | -0.73 | -0.01 | -7.03 | -4.93 | -1.50 | -0.97 | -0.76 | 39.3 |
| Ex. 6b | 8 | Teal | -6.98 | -2.78 | -0.39 | 0.25 | 0.80 | -17.01 | -9.88 | -2.83 | -1.31 | -0.70 | -42.6 |
| Ex. 6c | 9 | Blue | 0.87 | 1.45 | 1.15 | 1.01 | 1.28 | -21.95 | -12.38 | -3.13 | -1.12 | -0.51 | 37.9 |
| Ex. 6d | 10 | Royal Blue | 10.12 | 5.92 | 1.99 | 1.10 | 1.22 | -21.28 | -11.83 | -2.65 | -0.94 | -0.48 | 40.6 |
| Ex. 6e | 11 | Purple | 19.60 | 10.59 | 2.77 | 1.35 | 1.27 | -20.09 | -10.84 | -2.38 | -0.80 | -0.42 | 39.7 |
| Ex. 6f | 12 | Orange | 18.76 | 10.42 | 3.55 | 1.48 | 1.29 | 26.11 | 13.24 | 3.78 | 1.46 | 0.94 | 40.8 |
| Ex. 6g | 14 | Orange | 16.33 | 9.08 | 3.20 | 1.33 | 1.15 | 32.55 | 16.29 | 4.47 | 1.70 | 0.99 | 41.2 |
| Ex. 6h | 16 | Gold | 7.61 | 4.31 | 1.86 | 0.99 | 0.90 | 40.20 | 20.67 | 6.50 | 2.76 | 1.62 | 39.3 |
| Ex. 6i | 18 | Gold | 1.27 | 2.46 | 0.93 | 0.61 | 0.67 | 37.84 | 20.46 | 6.77 | 2.58 | 1.62 | 38.9 |
| Ex. 6j | 21 | Gold | -2.28 | -0.98 | -0.72 | -0.30 | 0.17 | 22.28 | 12.84 | 6.46 | 3.33 | 2.08 | 35.9 |
| Ex. 6a | 24 | Light Gold | -2.33 | -1.16 | -0.90 | -0.37 | 0.16 | 20.72 | 11.56 | 5.77 | 2.38 | 1.44 | 33.8 |
| Ex. 6a | 28 | Yellow | -3.08 | -1.62 | -1.27 | -0.58 | 0.01 | 13.95 | 7.67 | 4.23 | 1.75 | 1.02 | 33.7 |
| Ex. 6a | 32 | Light Yellow | -3.54 | -1.86 | -1.29 | -0.67 | -0.12 | 11.63 | 6.80 | 3.72 | 1.72 | 1.27 | 32.7 |
| Ex. 6a | 37 | Light Yellow | -3.08 | -1.56 | -1.24 | -0.73 | -0.15 | 3.51 | 1.62 | 1.02 | 0.24 | 0.06 | 31.6 |

### Example 7: 3-Layer Material (Si—Al—Si)

In a similar set-up as in example 2, 3-layer materials were produced. The ebeam source was positioned 36 cm below the web during process and webspeed was held at a constant 19 m/min for Si deposition and 11 m/min for Al deposition. The ebeam source accelerating voltage was held at a constant 10 kV throughout the run. In a first step a Si-layer was deposited on a clear polyester film with a release coat layer using PVD ebeam evaporation. Ebeam current was set at the beginning of the run and webspeed was utilized to manipulate the silicon layer thicknesses. In a next step an Al layer was deposited corresponding to approximately 1.0 - 1.5 OD. Optical transmission sensors in combination with current adjustment was utilized to target appropriate Al thickness. In a third process step a further layer of Si was deposited using the same parameters as the first step. Again, ebeam current was set at the beginning of the run to manipulate silicon layer thicknesses. The thickness of the 2 silicon layers was targeted to be the same, so that the webside and metal side of each condition would be the same colour. Si thickness corresponding to yellow and gold was targeted for material 7a and 7b, respectively. Yellow and gold colouration films and subsequent pigments were successfully produced. The colouration of the web and metal side of the films matched well in each material set.

The materials obtained in Example 7 were all stripped from the polyester film and milled/crushed to a particle size of approximately 14 microns (D50 value). Pigments were prepared with a 10 wt.% in ethanol. Inks were prepared using a total metal content of 3.0 wt-% in a nitrocellulose binder system. The samples were drawn down on a flat BYK drawdown card. Gloss data were collected using a BYK Micro Tri-gloss meter. Additional optical data were collected using a BYK Mac meter. A comparison to Metalure L51010AE (commercially available aluminium PVD pigment from Eckart America) is shown in Table 8, 7c. The results of these measurements are summarised in Table 8.

TABLE 8

Optical data for Examples 7

| Sample | Gloss 20° | Gloss 60° | Flop | L*15 | a*15 | a*45 | a*110 | b*15 | b*45 | b*110 | Visual Color |
|---|---|---|---|---|---|---|---|---|---|---|---|
| Example 7a | 60.5 | 147 | 31.57 | 132.5 | -1.46 | 0.97 | 1.47 | 31.41 | 12.55 | 10.17 | Yellow |
| Example 7b | 56.1 | 142 | 35.6 | 127.3 | 0.31 | 1.49 | 2.23 | 35.89 | 12.38 | 9.25 | Gold |
| Comparative Example 7c | 75.9 | 170 | 25.25 | 139.2 | -0.56 | 0.65 | 0.45 | -0.28 | 2.86 | 2.12 | Silver |

1. An effect pigment comprising optically active layers, the optically active layers consisting of a flake of a highly reflective material and a layer of a semiconducting material directly adjacent on one side or on both sides of the flake, the semiconducting material having a bandgap of 0.1 to 3.5 eV.

2. The effect pigment according to claim 1, wherein the effect pigment is further encapsulated with an outer optically non-active layer.

3. The effect pigment according to claim 1, wherein the highly reflective material comprises aluminum, copper, chromium, titanium or gold.

4. The effect pigment according to claim 1, wherein the semiconductor material having a bandgap of 0.1 to 3.5 eV comprises germanium, silicon, an alloy of germanium and silicon, silicon monoxide, a non-stoichiometric chromium oxide (CrOₓ) or a non- stoichiometric aluminum oxide (AlOₓ).

5. The effect pigment according to claim 4, wherein the semiconductor material having a bandgap of 0.1 to 3.5 eV comprises germanium, silicon, or an alloy of germanium and silicon.

6. The effect pigment according to claim 1, wherein the flake of a highly reflective material has an average thickness in the range from 5 to 500 nm.

7. The effect pigment according to claim 1, wherein the at least one layer of the semiconductor material has a mean thickness in the range from 5 to 200 nm.

8. The effect pigment according to claim 1, the effect pigment including an optically non-active layer, wherein the optically non-active layer comprises one or more of a layer including Mo-oxide, a layer including SiO₂, a layer including Al₂O₃, and a layer including a surface modifier.

9. The effect pigment according to claim 1, wherein the flake of a highly reflective material comprises aluminum and the semiconductor material having a bandgap of 0.1 to 3.5 eV comprises germanium, silicon, or an alloy of germanium and silicon.

10. A method of manufacturing an effect pigment comprising optically active layers, the optically active layers consisting of a flake of a highly reflective material and a layer of a semiconducting material directly adjacent on both sides of the flake, the semiconducting material having a bandgap of 0.1 to 3.5 eV, the method using a PVD process comprising:
coating a thin, flexible substrate with a release coat agent,
depositing semiconductor layer 1 onto the flexible substrate using a roll-to-roll process,
depositing a layer of a reflective metal onto the semiconductor layer 1,
depositing a second semiconductor layer 2 onto the reflective metal layer, and
stripping a material stack comprising the semiconductor layer 1, the reflective metal, and the second semiconductor layer from the flexible substrate in a solvent.

11. The method of manufacturing according to claim 10, wherein the reflective metal has a thickness in a range of 5 to 500 nm.

12. The method of manufacturing according to claim 10, wherein the semiconductor layer 1 and semiconductor layer 2 are composed of the same material.

13. The method of manufacturing according to claim 10, wherein the semiconductor layers 1 and 2 have the same thickness.

14. A coating composition comprising an effect pigment according to claim 1 and a binder.

15. The coating composition according to claim 14 having a flop index in the range of 30 to 200.

16. The effect pigment according to claim 1, the effect pigment including an optically non-active layer, wherein the optically non-active layer comprises one or more of a layer including Mo-oxide, a layer including SiO₂, a layer including Al₂O₃, a layer including an organofunctional silane, a layer including a phosphate ester, a layer including a phosphonate ester, and a layer including a phosphite ester.

17. An ink composition comprising an effect pigment according to claim 1 and a binder.

18. The ink composition according to claim 17 having a flop index in the range of 30 to 200.

19. The method of claim 10, further including particle sizing, particle classification and solvent dispersion steps.
